(19) United States
(12) Patent Application Publication
(10) Pub. No.: US 2012/0254949 A1
(43) Pub. Date: Oct. 4, 2012

(54) METHOD AND APPARATUS FOR GENERATING UNIQUE IDENTIFIER VALUES FOR APPLICATIONS AND SERVICES

(75) Inventors: Tomi Matti Mikael Mikkonen, Espoo (FI); Antti Oskari Vähä-Sipilä, Helsinki (FI); Henri Tapani Kujala, Helsinki (FI); Ian Justin Oliver, Soderkulla (FI)

(73) Assignee: Nokia Corporation, Espoo (FI)

(21) Appl. No.: 13/099,677

(22) Filed: May 3, 2011

Related U.S. Application Data
(60) Provisional application No. 61/469,969, filed on Mar. 31, 2011.

(51) Int. Cl. G06F 21/00; G06F 15/16

(52) U.S. Cl. 726/4

(57) ABSTRACT

An approach is provided for adapting and regenerating identifiers for use in connection with applications and services available to a device. An identification generation platform receives a request to generate one or more identifiers associated with a device, a user of the device, or a combination thereof. At least one seed value associated with the device, the user of the device, or a combination thereof is determined. The platform then processes at least one seed value to cause, at least in part, a generation of the one or more identifiers.

### RELATED APPLICATIONS

This application claims the benefit of the earlier filing date under 35 U.S.C. §119(e) of U.S. Provisional Application Ser. No. 61/469,969 filed on Mar. 31, 2011, entitled “Method and Apparatus for Generating Unique Identifier Values for Applications and Services,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of development is ensuring the protection of private or sensitive information pertaining to the user or user devices that communicate over a network. By way of example, many applications and services operable by a device employ the use of identifiers for communicating with the various servers, backend databases and services they require to fulfill application processing tasks. Hence, a mapping application operable on a user device may engage a third party mapping service by indicating its unique identifier to facilitate the authentication, data sharing and location finding processes required for providing maps and directions to the mapping application. Unfortunately, the identifier passed along is static—i.e., it is directly linked to the user device and/or user employing the application or third-party service. The third-party service provider may subsequently correlate the identifier with the user by analyzing other data pertaining to the user or the device. Hence, confidentiality and privacy is limited as users do not have the ability to modify the identifiers or control the sharing and tracking of identifiers by third-party services.

### SOME EXAMPLE EMBODIMENTS

Therefore, there is a need for an approach for adapting and regenerating identifiers for use in connection with applications and services available to a device.

According to one embodiment, a method comprises receiving a request to generate one or more identifiers associated with a device, a user of the device, or a combination thereof, wherein the one or more identifiers are for use with one or more services, one or more applications, or a combination thereof. The method also comprises determining at least one seed value associated with the device, the user of the device, or a combination thereof. The method further comprises processing and/or facilitating a processing of the at least one seed value to cause, at least in part, a generation of the one or more identifiers.

According to another embodiment, an apparatus comprises at least one processor, and at least one memory including computer program code, the at least one memory and the computer program code configured to, with the at least one processor, cause, at least in part, the apparatus to receive a request to generate one or more identifiers associated with a device, a user of the device, or a combination thereof, wherein the one or more identifiers are for use with one or more services, one or more applications, or a combination thereof. The apparatus is also caused to determine at least one seed value associated with the device, the user of the device, or a combination thereof. The apparatus is further caused to process and/or facilitate a processing of the at least one seed value to cause, at least in part, a generation of the one or more identifiers.

According to another embodiment, a computer-readable storage medium carries one or more sequences of one or more instructions which, when executed by one or more processors, cause, at least in part, an apparatus to receive a request to generate one or more identifiers associated with a device, a user of the device, or a combination thereof, wherein the one or more identifiers are for use with one or more services, one or more applications, or a combination thereof. The apparatus is also caused to determine at least one seed value associated with the device, the user of the device, or a combination thereof. The apparatus is further caused to process and/or facilitate a processing of the at least one seed value to cause, at least in part, a generation of the one or more identifiers.

According to another embodiment, an apparatus comprises means for receiving a request to generate one or more identifiers associated with a device, a user of the device, or a combination thereof, wherein the one or more identifiers are for use with one or more services, one or more applications, or a combination thereof. The apparatus also comprises means for determining at least one seed value associated with the device, the user of the device, or a combination thereof. The apparatus further comprises means for processing and/or facilitating a processing of the at least one seed value to cause, at least in part, a generation of the one or more identifiers.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of adapting and regenerating identifiers for use in connection with applications and services available to a device, according to one embodiment;

FIG. 2 is a ladder diagram depicting a process for adapting and regenerating identifiers for use in connection with applications and services available to a device, according to one embodiment;

FIGS. 3A-3D are flowchart of processes for adapting and regenerating identifiers for use in connection with applications and services available to a device, according to various embodiments;

FIG. 4 is a diagram depicting identifier correlation or restricted correlation among services, according to various embodiments;

FIG. 5 is a diagram depicting a user interface of a device for enabling a user to request adapting and regenerating of identifiers, according to one embodiment;

FIG. 6 is a diagram depicting a user interface for tracking the use of identifiers in connection with applications and services available to a device, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for adapting and regenerating identifiers for use in connection with applications and services available to a device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to services and applications executable by way of a user device, it is contemplated that the approach described herein may be used within the context of user device interaction with network systems, support systems, backend systems, web services, cloud-based architectures, or the like.

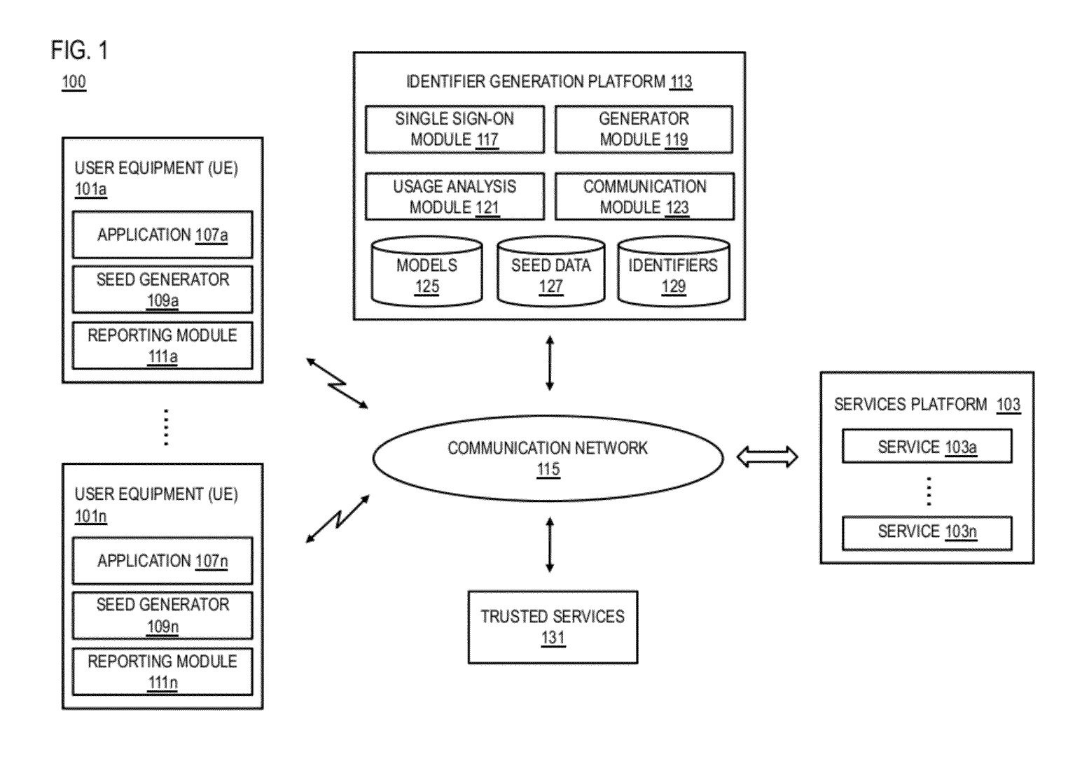

FIG. 1 is a diagram of a system capable of adapting and regenerating identifiers for use in connection with applications and services available to a device, according to one embodiment. By way of example, the system enables users of devices, i.e., user equipment (UE) 101a-101n, to generate, regenerate or pre-generate one or more identifiers to be used in connection with the performance of tasks by an application 107a-107n operable at the device. An identifier generation platform 113 operates in connection with UEs 101a-101n to facilitate generation of the identifiers based on processing of one or more seed values generated in association with respective UE 101a-101n. “Seed values” or “seeds,” may for example, be any integer values used to set the starting point for generating a series of random numbers, i.e., random and/or unique identifiers. The seed sets the generator, such as provided by way of the identifier generation platform 113, to a random, unpredictable starting point. As such, a unique seed returns a unique random number sequence.

Many applications and services operable by user devices such as cellular phones, laptops and other wireless communication devices employ the use of identifiers for communicating with the various servers, backend databases and services they require to fulfill application processing tasks. For example, when access to a third-party service is required by an application or service available to the user through the device, certain application tasks may be facilitated by sending a request message to the third-party service by way of a communication interface of the device. The request message may indicate, among other things, data for indicating the nature of the request, location information for the user device, message decoding and generation instructions, at least one identifier associated with the user device or requesting application, etc. Identifiers passed along in such instances may include a universally unique identifier (UUID), a globally unique identifier (GUID), international mobile equipment identifier (IMEI) or the like.

Typically, the third-party service provider being called upon by an application or service operable by a user device is a separate entity or provider from the communication service provider that hosts, supports and enables execution of wireless services by the device over an established communication network. By way of example, a television media player application operable on a user device may engage a media content service that is hosted by a third-party service provider. Although the user device operates over a dedicated/trusted communication network, fulfillment of tasks pertaining to the media player such as replaying a missed show or viewing a live broadcast is enabled by the third-party. Hence, the calling media player application indicates a unique identifier of the device, user, service or application in order to facilitate the required authentication, data sharing and content retrieval processes.

Unfortunately, the identifier is static, and therefore, capable of being directly linked to the user device, requesting service/application and/or user engaging with the third-party service. Consequently, the third-party service provider can track and store the identifier values as passed along by numerous user devices and subsequently attempt to match the identifiers values maintained by other third-party services. By way of example, the media content service provider may exchange identifier values and associated service and/or profile information with a mapping application service provider that also tracks and stores identifier values and associated service and/or profile information. Through a process of deduction, information sharing and data analysis, one or more of the third-party service providers may correlate the identifier with a specific user or user device—i.e., determine the name, e-mail address, location or profile of a user. Hence, the static nature of identifier values poses a challenge to maintaining the confidentiality and privacy of the user. This is especially problematic for communication service providers, who are required by law in certain instances, to observe user privacy protection protocols as well as provide assurance to their customers.

To address this problem, a system 100 of FIG. 1 introduces the capability for a user device to generate seed values to be used for further generation or regeneration of unique identifier values. The unique identifier values may then be used in connection with the accessing of one or more services 103a-103n as provided by a third-party services platform 103, a trusted service 131, or a combination thereof. By way of example, UE 101a-101n is configured with one or more applications 107a-107n for performing various processing tasks by way of the device. Applications executable by UE 101a-101n may include, for example, a mapping application, location application, a social networking application, a contact management application, a document processing application, a network conferencing application, a chat application, an e-mail application, a data synchronization application, a media content provisioning application, a weather data application, etc. For the purpose of illustration, an application 107 operable via UE 101a-101n is synonymous with a service executable from said device and may be described interchangeably unless otherwise noted.

In certain embodiments, UE 101a-101n is configured with a seed generator 109a-109n that generates random, unpredictable seed values (e.g., a random number generator). The seed generator 109 performs seed generation on a scheduled basis as established by a user of UE 101a-101n, on demand or in response to a request for execution or access to a service 103a-103n and/or 131. The seed generator 109 may be accessed through the device by way of a user interface for presenting users with various control and configuration options. Still further, the seed generator 109 determines a first time use, an initialization, or a combination thereof of the device 101a-101n and/or applications 107a-107n. When first time use is determined, for example, the seed generation is configured to generate at least one seed value based on the first time use, the initialization, or a combination thereof. This approach ensures proper seeding of application requests regardless of the prior state of the UE 101a-101n and/or calling application 107a-107n.

In addition, a reporting module 111a-111n operates in connection with the various applications 107a-107n for maintaining statistics regarding application usage, device usage and the like in connection with one or more services 103a-103n and 131. It is noted the application 107a-107n, seed generator 109a-109n and reporting module 111a-111n of respective UE 101a-101n are each configured to communicate singularly, or in combination, with an identifier generation platform 113 by way of communication network 115.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, identifier generation platform 113 and services 103a-103n and/or 131 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The identifier generation platform 113 of system 100 is a processing system or service operable by or in connection with UEs 101a-101n. Seed values, once generated by the seed generator 109a-109n of respective UEs 101a-101n, are transmitted to and stored by the identifier generation platform 113 as seed data 127. In certain embodiments, seed values may be piggybacked or chained to maximize data transmission and efficiency.

In certain embodiments, the identifier generation platform 113 is configured to process the seed data 127 (e.g., at least one seed value) based, at least in part, on one or more value generation models 125 useful for generating a unique identifier. The models may include for example, data for supporting execution of an encryption-based hash function (e.g., 256-bit Hash-based Message Authentication Code/Secure Hash Algorithm, referred to as HMAC-SHA-256), a data normalization algorithm, data transposition logic, a key and/or table processing algorithm, or a combination thereof.

By way of the identifier generation platform 113, unique identifier values may be used in connection with a calling application 107a-107n or service of the device, i.e., to enable fulfillment of processing tasks or service requests involving third-party services. Third-party services may be accessed over a communication network 115 by respective UEs 101a-101n via a services platform 103 for implementing and/or maintaining one or more services 103a-103n. Third-party services maintained by the service platform 103 (e.g., as hosted by one or more respective third-party service providers) may include, for example, a mapping service, location service, a social networking service, a contact management service, a document processing service, a network conferencing service, a chat service, an e-mail service, a data synchronization service, a media content provisioning service, a weather data service, etc. In addition, the service may be that for supporting a single-sign on service or group, including services for enabling multiple individual services to be connected via one sign-on service (SSO) or process (e.g., Microsoft Live, Google Apps, cloud-based SSO, etc.). It is noted that the service platform 103 may be implemented as one or more servers, backend systems, data system infrastructures, web services, etc. Furthermore, a single services platform 103 may provide multiple services 103a-103n or alternatively, multiple service platforms 103 may be accessed for enabling specific processing needs of calling applications 107a-107n.

The identifier generation platform 113 is also configured to present a communication interface through which the one or more services 103a-103n of the platform 103 may be engaged. The communication interface is a medium in which the applications 107a-107n may pass along requests for the services 103a-103n; the request messages generated to include at least one unique identifier generated based on at least one seed value. In certain embodiments, multiple seeds may be generated by a given UE 101 for generating multiple unique identifiers for associating with multiple individual calls for access to a third-party service 103. In other embodiments, a single seed value may be used for generating multiple unique identifiers 129. It is noted, therefore, that the identifier generation platform 113 manages the generation and provisioning of identifiers 129 based on the requirements of the particular service in question.

As noted, the ability of the identifier generation platform 113 to (1) enable passage of third-party service calls and communications through an intermediary interface; and (2) generate unique identifiers by processing seed data 127 based on models 125 defining a specific algorithm or hash function; enables the identifier generation platform 113 to restrict the sharing and exchanging of identifier values among third-party services 103a-103n. By way of example, the intermediary interface serves as a channel for exposing requesting applications 107a-107n and services of the device to services of the service platform 103 or trusted service 131. In certain embodiments, the interface may be permitted to only enable passage of seed data 127 from the platform 113 to one or more trusted services 131 based on a determination of a requirement of accessing a trusted service 131 by applications 107a-107n. Upon determination of one or more third-party services 103a-103n being accessed, however, the interface restricts the passage of the seed data.

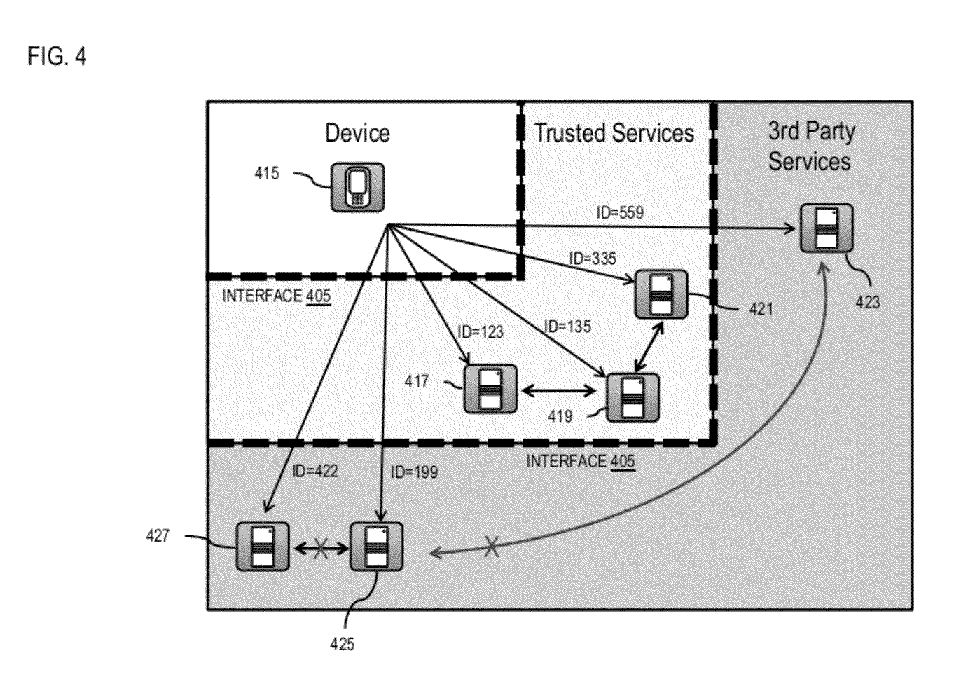

It is noted that without specific access to the particular model 125 and/or seed value (e.g., key) utilized to generate identifiers; third-party services 103a-103n cannot regenerate identifier values. Consequently, respective third-party services 103a-103n or providers thereof are prevented from correlating specific identifier values with a particular user and/or UE 101A-101n. In contrast, seed values are permitted for sharing among one or more trusted services 131a, which enables the calculating/generating and subsequent sharing of unique identifiers via the communication interface among trusted services 131. This execution is presented more fully later on with respect to FIG. 4.

The identifier generation platform 113 comprises various components for facilitating the generating and/or regenerating of unique identifier values. Generating of identifier values includes, for example, the initial processing of seed data 127 for enabling the generation of one or more unique identifiers to be used in connection with one or more applications 107a-107n and/or services 103a-103n. Regenerating of identifiers includes, for example, subsequent processing of prior generated seed data 127 for enabling the derivation of prior generated unique identifiers. Per the above described settings and features of the identifier generation platform 113, the generation and regeneration process may be performed only between trusted services 131 that interact with UEs 101a-101n. No means of generation or regeneration of identifiers is possible between third-party services 103a-103n.

It is contemplated that the functions of the platform 113 is performed by way of one or more executable components. The components may be combined into one or more components or performed by other components of equivalent functionality. In this embodiment, the identifier generation platform 113 includes a single sign-on service module 117 for facilitating execution of SSO based communication services and tasks in response to a request by a calling application 107a-107n or service of UE 101a-101n. In certain embodiments, the single-sign on (SSO) module 117 is also configured to operate in connection with a communication module 123 for enabling execution of SSO services via the intermediary communication interface. By way of example, single sign on is generation models 125. The models 125 define an encryption-based hash function (e.g., 256-bit Hash-based Message Authentication Code/Secure Hash Algorithm, referred to as HMAC-SHA-256), a data normalization algorithm, data transposition logic, a key and/or table processing facilitated in accord with a call to an enabling SSO service 103a-103n.

A generator module 119 is also configured to generate unique identifier values by processing the seed data 127 as received from seed generators 109a-109n at respective UE 101-101n. As mentioned previously, the generator module 119 processes the seed data 127 (e.g., at least one seed value) using one or more hash functions, data normalization algorithms, data transposition logic, key and/or table processing algorithms, or a combination thereof for generating unique identifiers 129.

By way of example, the generator module 119 may be configured to generate identifier values based on the following encryption-based hash function/schema:

Identifier Value=HMAC-SHA-256(seed, service_name, SQN)

In this example, the HMAC-SHA-256 algorithm is a function of at least one seed value maintained as seed data 127, the seed value corresponding to a random number. It is also a function of, or passed a service name parameter corresponding to a Java Naming and Directory Interface (JNDI). JDNI is, for example, a directory service for enabling the discovery and look up of data and objects via a name. In particular, the service name corresponds to that of the particular service 103a-103n to be accessed for fulfillment of an application 107a-107n processing task at UE 101a-101n. It is noted that the generator module 119 may access a JDNI application programming interface (API) to (1) facilitate the binding of an object (e.g., a service 103) to a service name; (2) enable generation of the intermediary interface, such as to support directory lookup; (3) enable the execution of queries or directory lookup via the intermediary interface.

Still further, the example function above also includes a sequence number for indicating the sequence of a particular service call, request and/or directory lookup performed in connection with an application 107a-107n. Based on the above described inputs, the unique identifier as generated takes the following format: Id (value)|SQN; a combination of a numeric or alphanumeric identifier value and a specific sequence number. Depending on communication services provider preferences, additional parameters (e.g., checksum, status code) may also be included for generating the unique identifiers.

The generator module 119 is configured to generate identification values on a scheduled basis as established by a user of UE 101a-101n or in response to historic application 107a-107n usage needs, on demand, such as to regenerate an identifier on behalf of a trusted service, or in response to an initial request for execution or access to a service 103a-103n and/or 131. In certain embodiments, the generator module 119 may also pre-generate one or more identifiers, such as in anticipation of future application and/or service calls. Once seed data is processed, the generator module 119 stores the unique identifiers to the identifier database 129.

Of note, the generator module 119 may facilitate execution of the intermediary interface for enabling the calling of services and passage of identifiers in conjunction with the communication module 123. By way of example, the communication module supports execution of the intermediary interface over the communication network 115. In one embodiment, the communication module 123 enables formation of a session over the network 115 between the identifier generation platform 113 and the application 107, seed generator 109 or reporting module of respective UE 101. This includes execution of various protocols and data sharing techniques for enabling collaborative execution between a subscriber's user device 101a-101n (e.g., mobile devices, laptops, smartphones, tablet computers, desktop computers) and the identifier generation platform 113 over the network 115. It is noted that the communication module 123 may also interact with the JDNI API for supporting execution of the intermediary interface to enable the calling of various services 103a-103n or trusted services 131.

In one embodiment, a usage analysis module 121 is configured to receive report data from the reporting modules 111a of respective UE. By way of example, the usage analysis module enables the generation of reports regarding the usage of one or more identifiers in connection with the execution of one or more applications 107a-107n, one or more services 103a-103n, trusted services 131, or a combination thereof. The usage analysis module 121 also facilitates execution of a reporting interface, wherein an operator of the trusted services 131 (e.g., an operator of the communication service provider), is able to view reports, perform analytics, etc. By way of the interface, trusted services may correlate an identifier to a specific user via the intermediary interface.

While shown as a separate entity, it is contemplated in certain embodiments that the identifier generation platform 113 may be integrated with the seed generator 109 or reporting module 111; the operation of which is suitable for supporting generation of unique identifiers in response to the accessing on one or more services. Hence, the identifier platform 113 may be directly executable by UE 101. It is noted that integration and/or communication between the identifier generation platform 113, services platform 103, trusted services 131 and one or more UE 101a-101n is facilitated by way of a communication network 115. The communication network 115 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof.

In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

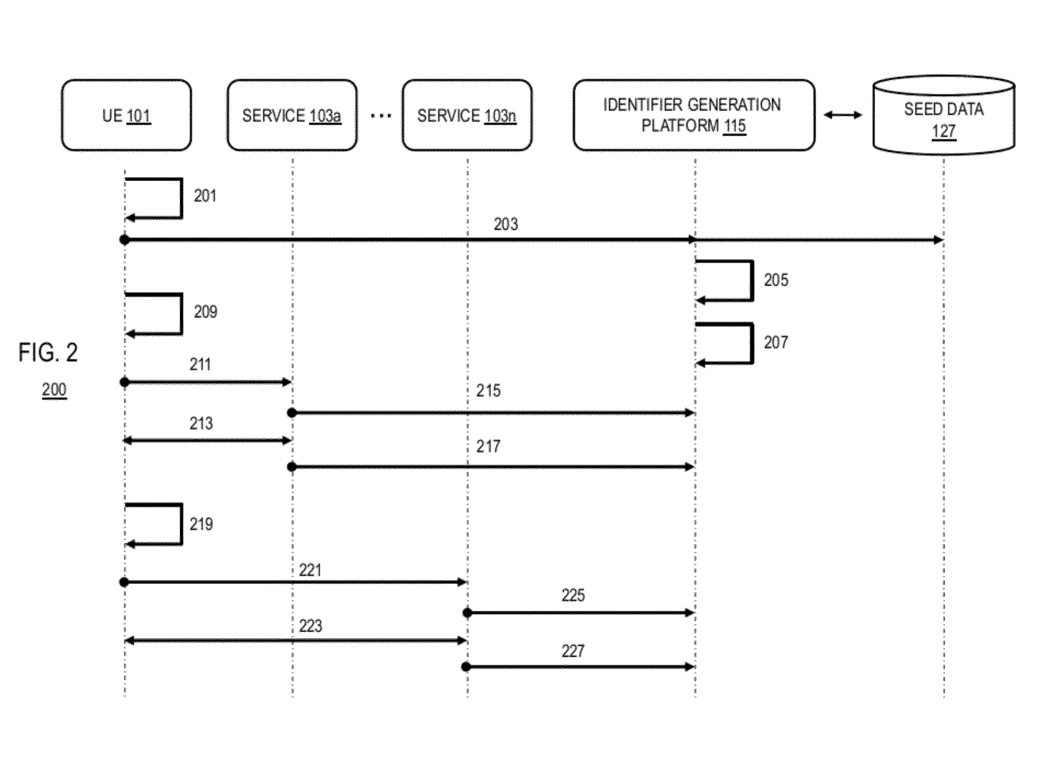

FIG. 2 is a ladder diagram depicting a process for adapting and regenerating identifiers for use in connection with applications and services available to a device, according to one embodiment. In steps 201 and 203 of the process 200, UE 101 generates seed values and transmits the values to the identifier generation platform 113, where the values are subsequently stored as seed data 127. The generator module of the platform 113 accesses the seed data 127 to generate one or more identifiers accordingly, corresponding to step 205. Per step 207, the identifiers are then delivered to the single sign-on module for execution of SSO based communication. Alternatively, the identifiers as generated are passed along or made available for use in connection with services 103a-103n. It is noted that the delivery process is facilitated by way of the intermediary interface.

In step 209, a service name is specified by the user device. By way of example, this corresponds to selection or activation of a particular application function or task via an application 107 that requires use of a service 103a-103n. Consequently, the applications submit a request for access to service 103a by specifying the corresponding service name, per step 211. Once the service is found, i.e., by way of the intermediary interface, a communication session between the application at the device 101 and the service 103a is established, corresponding to step 213. Also, usage statistics and other data pertaining to execution of the service with respect to the assigned identifier value is recorded and reported to the identifier generation platform 113 accordingly per steps 215 and 217. While not shown, it is noted that the identifier generation platform 113 performs a determination of the level of trust of the associated service so as to determine if seed values may be shared. As mentioned previously, only trusted services may access seed values for enabling identifier regeneration and sharing.

Steps 219-227, as performed with respect to the accessing of service 103n, is identical to steps 209-217, as performed with respect to the accessing of service 103a. In this case, a determination is made to identify whether the service 103n corresponds to a trusted service, such as that provided by a service and/or application of the provider of the communication network 115.

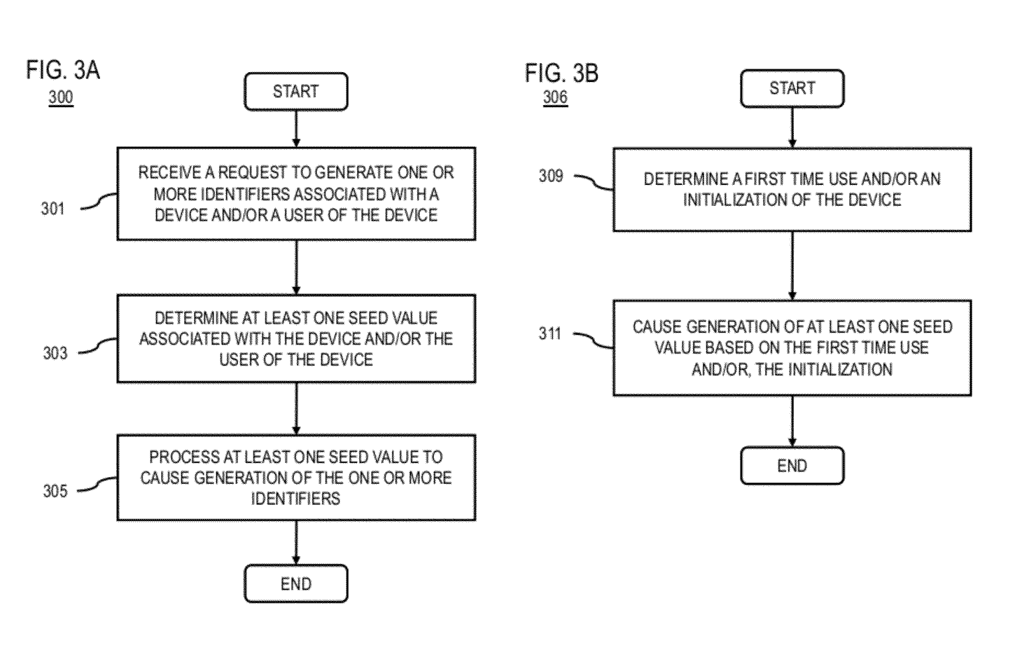

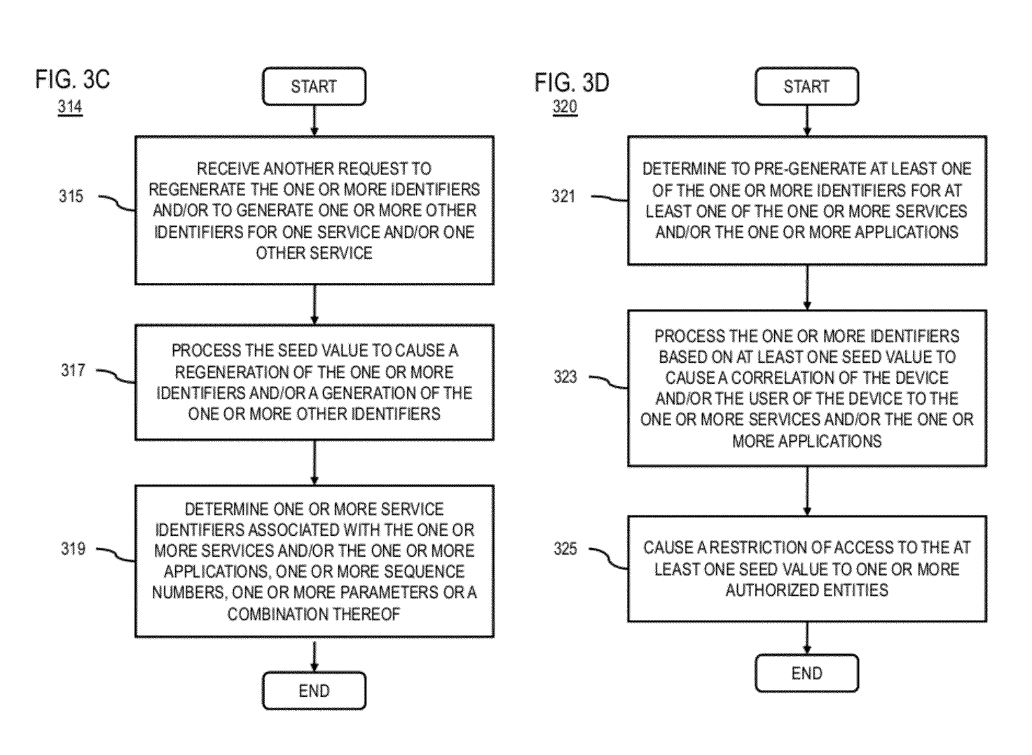

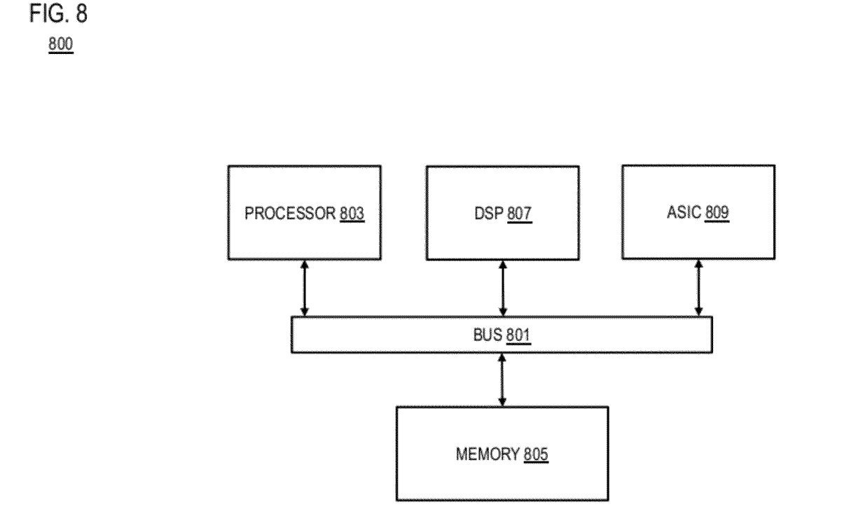

FIGS. 3A-3D are flowchart of processes for adapting and regenerating identifiers for use in connection with applications and services available to a device, according to various embodiments. In one embodiment, the identifier generation platform 113 that performs processes 300, 306, 314 and 320 is implemented in, for instance, a chip set including a processor and a memory as shown in FIG. 8. For the purpose of illustration, the processes are described with respect to FIG. 1. It is noted that the steps of the process may be performed in any suitable order, as well as combined or separated in any suitable manner.

In step 301, of process 300, the identifier generation platform 113 receives a request to generate one or more identifiers associated with a device and/or user of the device. As mentioned, the one or more identifiers are to be used in association with one or more services, applications, etc. In another step 303, the platform 113 determines at least one seed value associated with the device and/or the user of the device. Generation of the at least one seed value includes generation of a random number. In certain implementations, the seed value may be implemented as an alphanumeric value, or include a symbol or other data point. Per step 305, the platform 113 processes at least one seed value to cause generation of the one or more identifiers.

In step 309 of process 306 (FIG. 3B), the platform 113 determines a first time use an initialization of the device. First time use may correspond to an initial registration process of the device, application or service, initial activation of the device, application or service, etc. The determination may be based upon detection of an authentication process, a direct specification of first time use by a user with the identification generation platform 113 or a given service 103-103n, or a combination thereof. Per step 311, the identification generation platform 113 causes generation of at least on seed value based on the first time use and/or initialization as determined.

In FIG. 3C, step 315 of process 314, the identification generation platform 113 receives another request to regenerate the one or more identifiers and/or to generate one or more other identifiers for one service and/or one other service. Per step 317, the identification generation platform 113 processes the seed value to cause a regeneration of the one or more identifiers and/or generation of the one or more identifiers. As mentioned previously, the regeneration process may be performed respective to communication between trusted services, which are those allowed to access seed values and thus regenerate identifiers. As a matter of consumer/user privacy, only trusted services most pertinent to the user may perform the regeneration function.

In step 319 of process 314, the identification generation platform 113 determines one or more service identifiers associated with the one or more services and/or the one or more applications (at the user equipment 101). Also determined are the one or more sequence numbers and/or one or more parameters. As mentioned above, generation of the one or more identifiers is based on the service identifiers (e.g., a JNDI service name), the sequence numbers and the one or more other parameters. These values are compiled as well with respect to the seed value.

In step 321 of process 320 (FIG. 3D), the identification generation platform 113 determines to pre-generate at least one of the one or more identifiers for at least one of the one or more services and/or one or more applications. Pre-generation may be performed such as in anticipation of future application and/or service calls from one or more devices. The pre-generation process may also be performed as part of a resource allocation or load balancing scheme, wherein significant access to services by a multitude of devices necessitates predetermined allocation of data resources. As noted, in certain embodiments, the one or more services and/or applications may be part of a single sign-on group, such as to facilitate SSO communication.

In step 323, the platform 113 processes the one or more identifiers based on at least one seed value to cause a correlation of the device and/or the user of the device to the one or more services and/or the one or more applications. Per step 325, in contrast to step 323, the identification generation platform causes restriction of access to the at least one seed value to one or more authorized entities. In this case, the correlation is performed by or on behalf of the one or more authorized entities. As noted above, the authorized entities may include trusted services as provided by trusted and/or known service providers. Authorized third-party entities/providers may be restricted from accessing seed values however.

FIG. 4 is a diagram depicting identifier correlation or restricted correlation among services, according to various embodiments. A user device 415 may access one or more services and/or applications by way of the identification generation platform (not shown). Per the execution described above, the platform provides an intermediary interface 405, represented by the dashed line, for accessing trusted services (e.g., backend systems, databases, web services) or third-party services. The identification generation platform enables generation of identifier values 335, 135 and 123 based on the generation of seed values provided by the device 315 for communicating with the one or more trusted services 421, 419 and 417 respectively. In addition, identifier values 559, 199 and 422 are generated for accessing of services 423, 425 and 427 respectively.

By way of the access protocol facilitated by the identification generation platform, correlation of amongst trusted services 417-421 is facilitated since seed values may be passed between services for enabling recalculation of identifiers. This recalculation process may be performed at the request of a user or seamless via intra-service communication. Correlation amongst third party services 423-427, however, is not facilitated as seed values are not allowed to be shared and/or passed between services.

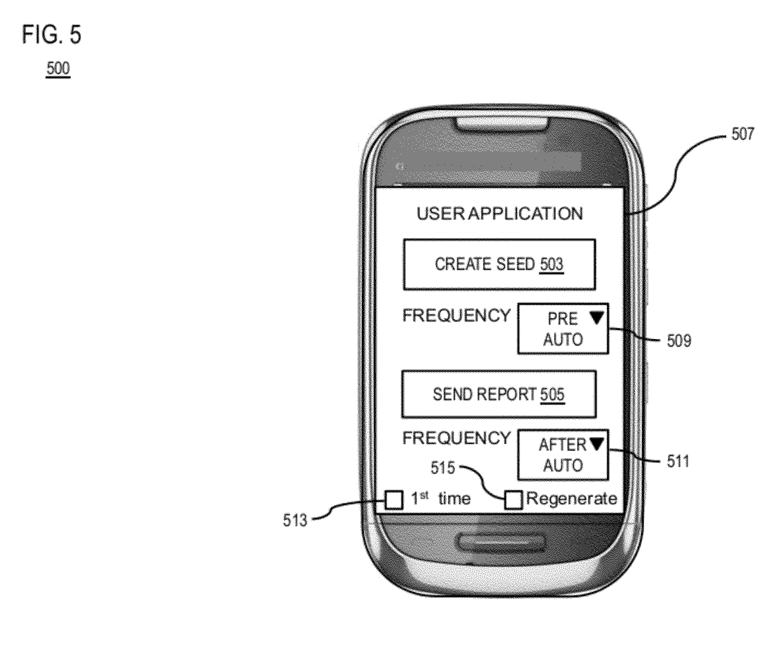

FIG. 5 is a diagram depicting a user interface of a device for enabling a user to request adapting and regenerating of identifiers, according to one embodiment. The interface 507 of the device 500 features various actions buttons, menus and other interaction devices for enabling user interaction with the various controls and settings offered by the identification generation platform 113. In certain instances, presentment of the user application to the interface occurs due to launching of the application by a user. In other embodiments, it is contemplated that the interface 507 is caused to be presented automatically, such as in response to accessing of a service by an application and/or service of the device 500.

By way of example, a “CREATE SEED” action button 503 may be selected by the user for enabling on demand or one-time generation of a random number to be used for generation of an identifier. Alternatively, the user may select an alternative frequency of seed generation from a frequency selection menu 509. Selection options include “PRE” for enabling pre-generation of seed values, such as in accordance with historical service and/or application access by the user. Another selection option includes “AUTO,” wherein the identification generation platform 113 determines the frequency of seed generation.

A “SEND REPORT” action button 505 is also featured for enabling a user to generate and send usage data and statistics to the identification generation platform 113, such as in response to the execution of an application and/or service. The user may also select from a report frequency selection menu 511. Selection options from the menu 511 include an “AFTER” option for enabling generation of reports after performance of the service and/or application. Another selection option includes “AUTO,” wherein the identification generation platform 113 determines the frequency of reporting.

A first-time use check box 513 is also featured for enabling a user to specify first-time activation and/or initialization of the device, a particular application and/or service of the device, etc. Also included is a regeneration checkbox 515. While not shown expressly, selection of the regeneration checkbox may cause presentment of a list of the various trusted services and their prior associated identifiers. The user may select (e.g., tap) the particular identifier from the list corresponding to the service they wish to regenerate.

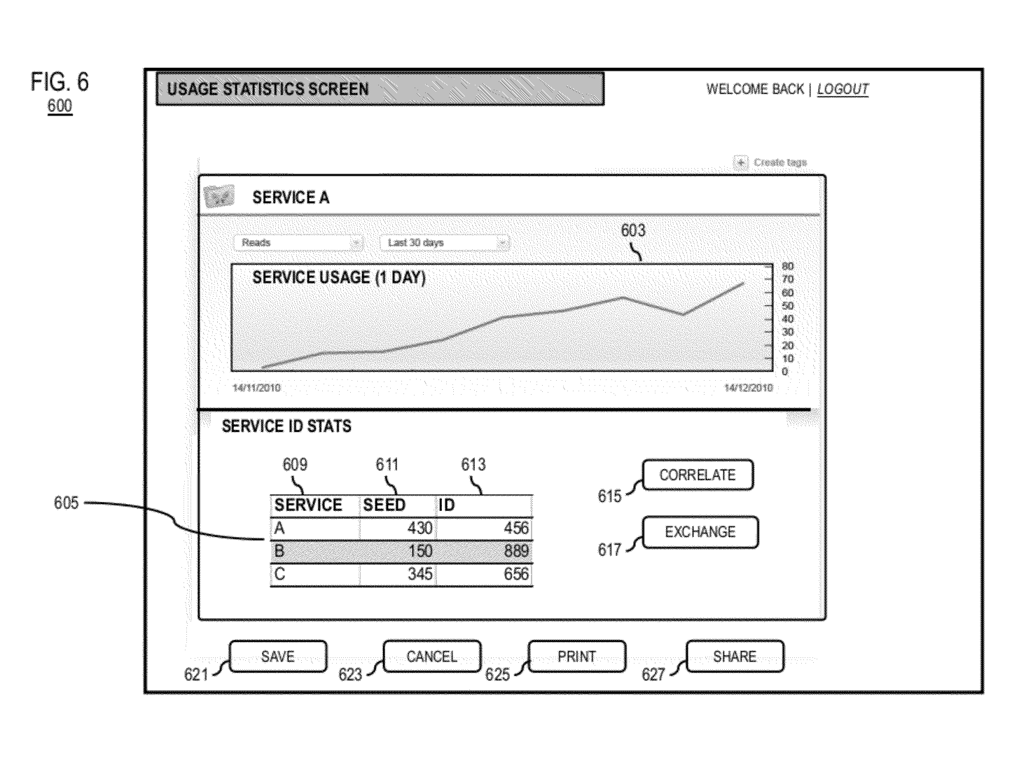

FIG. 6 is a diagram depicting a user interface for tracking the use of identifiers in connection with applications and services available to a device, according to one embodiment. By way of example, the usage statistics screen 600 is accessed by a trusted service provider via a web browser or web portal. The usage statistics screen presents various data, including graphs 603 and tables/cells (of a spreadsheet 605) for indicating various service/application and/or identifier usage statistics. Compilation of this data may be used to generate a report for indicating the effectiveness identifier use and for tracking service usage in connection with specific users to which the identifiers are correlated.

By way of example, the spreadsheet 605 of the tag statistics screen 600 presents the various columns of data, including a service name column 609 for specifying a particular service (e.g., third-party or trusted), a seed column 711 for indicating a specific seed value used in association with a given service and a identifier value for indicating the identifier value generated for the service based on the seed value. Under this scenario, service A-C corresponds to identifiers 456, 889 and 656 respectively.

A “CORRELATE” action button 615 is featured for enabling the user to perform a correlation between a selected service and/or identifier value and a particular user. While not shown expressly, selection of this button invoke presentment of an additional window or list for featuring profile information or other determined correlation data for a particular user and/or user device.

An “EXCHANGE” action button 617 is featured for enabling the user to select which of the trusted services (e.g., service A and C) are able to exchange identifier values for permitting correlation. In this example, no exchange or correlation process may occur with respect to service B, which is shaded in the list and not open for selection.

Upon generating and viewing the reports and statistics, the merchant can save customer generated reports by selecting a “SAVE” action button 621, cancel reports by selecting a “CANCEL” action button 623, print reports by selecting a “PRINT” action button 625 and share reports by selecting a “SHARE” action button 627.

The processes described herein for adapting and regenerating identifiers for use in connection with applications and services available to a device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

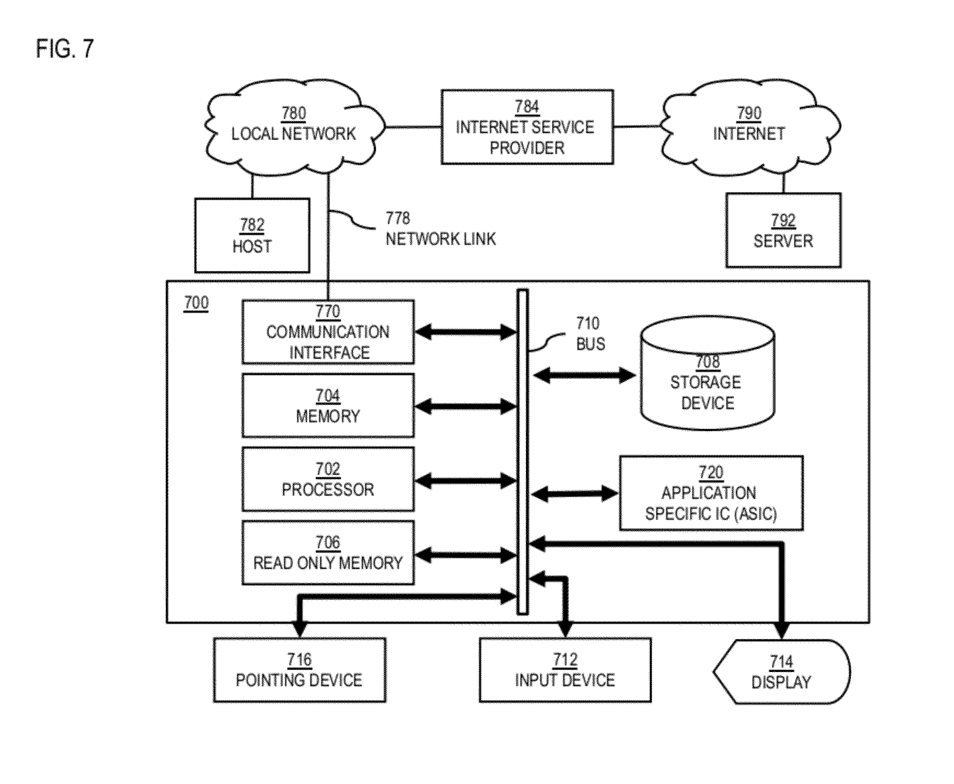

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) adapt and regenerate identifiers for use in connection with applications and services available to a device as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps adapting and regenerating identifiers for use in connection with applications and services available to a device.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related adapt and regenerate identifiers for use in connection with applications and services available to a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for adapting and regenerating identifiers for use in connection with applications and services available to a device. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for adapting and regenerating identifiers for use in connection with applications and services available to a device, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for adapting and regenerating identifiers for use in connection with applications and services available to a device to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed adapt and regenerate identifiers for use in connection with applications and services available to a device as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps adapting and regenerating identifiers for use in connection with applications and services available to a device.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein adapt and regenerate identifiers for use in connection with applications and services available to a device. The memory 805 also stores the data associated with or generated by the execution of the inventive steps.

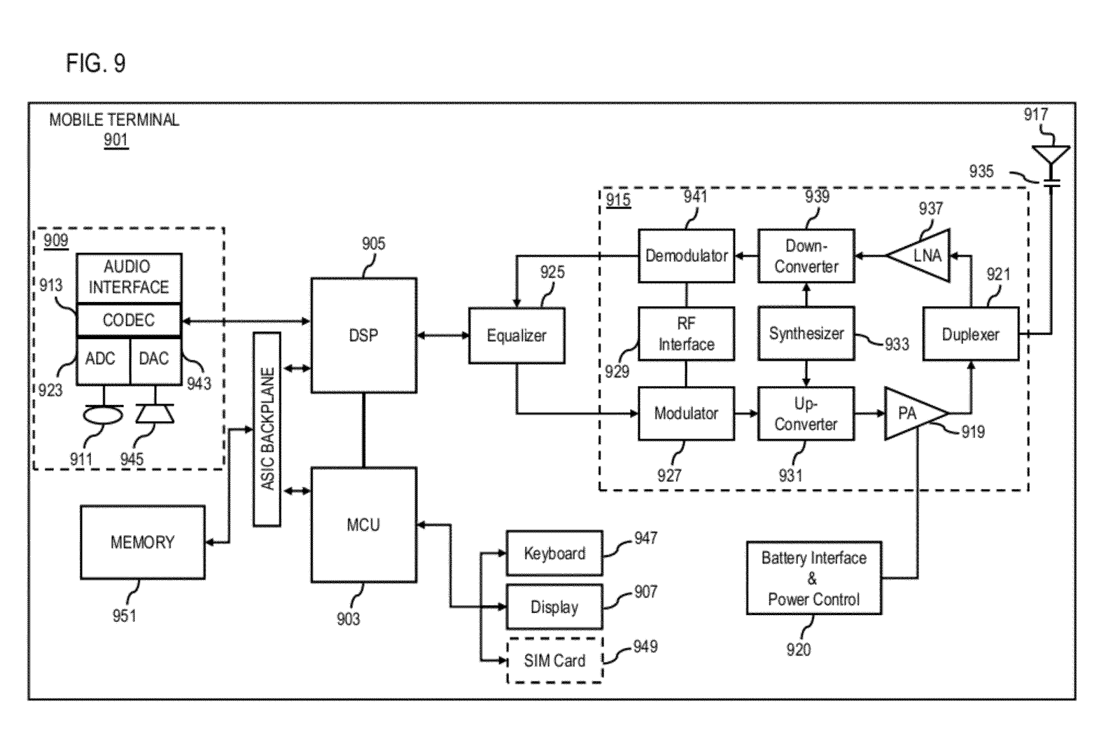

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps adapting and regenerating identifiers for use in connection with applications and services available to a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps adapting and regenerating identifiers for use in connection with applications and services available to a device. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 adapt and regenerate identifiers for use in connection with applications and services available to a device. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a request to generate one or more identifiers associated with a device, a user of the device, or a combination thereof, wherein the one or more identifiers are for use with one or more services, one or more applications, or a combination thereof;
at least one seed value associated with the device, the user of the device, or a combination thereof; and
a processing of the at least one seed value to cause, at least in part, a generation of the one or more identifiers.

2. A method of claim 1, wherein the (1) data and/or (2) information and/or (3) at least one signal are further based, at least in part, on the following:
a first time use, an initialization, or a combination thereof of the device; and
a generation of the at least one seed value based, at least in part, on the first time use, the initialization, or a combination thereof.

3. A method of claim 2, wherein the generation of the at least one seed value is based, at least in part, on one or more random values.

4. A method of claim 1, wherein the (1) data and/or (2) information and/or (3) at least one signal are further based, at least in part, on the following:
another request to regenerate the one or more identifiers, to generate one or more other identifiers, or a combination thereof for the at least one service, at least one other service, or a combination thereof; and
a processing of the seed value to cause, at least in part, a regeneration of the one or more identifiers, a generation of the one or more other identifiers, or a combination thereof.

5. A method of claim 1, wherein the (1) data and/or (2) information and/or (3) at least one signal are further based, at least in part, on the following:
(a) one or more service identifiers associated with the one or more services, the one or more applications, or a combination thereof, (b) one or more sequence numbers, (c) one or more other parameters, or (d) a combination thereof,
wherein the generation of the one or more identifiers is further based, at least in part, on the one or more service identifiers, the one or more sequence numbers, the one or more parameters, or a combination thereof.

6. A method of claim 1, wherein the (1) data and/or (2) information and/or (3) at least one signal are further based, at least in part, on the following:
at least one determination to pre-generate at least one of the one or more identifiers for at least one of the one or more services, the one or more applications, or a combination thereof.

7. A method of claim 6, wherein the at least one of the one or more services, the one or more applications, or a combination thereof are part of a single sign-on group.

8. A method of claim 1, wherein the (1) data and/or (2) information and/or (3) at least one signal are further based, at least in part, on the following:
a processing of the one or more identifiers based, at least, in part, on the at least one seed value to cause, at least in part, a correlation of the device, the user of the device, or a combination thereof to the one or more services, the one or more applications, or a combination thereof.

9. A method of claim 8, wherein the (1) data and/or (2) information and/or (3) at least one signal are further based, at least in part, on the following:
a restriction of access to the at least one seed value to one or more authorized entities,
wherein the correlation is performed by or on behalf of the one or more authorized entities.

10. A method of claim 1, wherein the generation of the one or more identifiers is based, at least in part, on one or more encryption-based hash functions.

11. An apparatus comprising:
at least one processor; and
at least one memory including computer program code for one or more programs,
the at least one memory and the computer program code configured to, with the at least one processor, cause the apparatus to perform at least the following,
receive a request to generate one or more identifiers associated with a device, a user of the device, or a combination thereof, wherein the one or more identifiers are for use with one or more services, one or more applications, or a combination thereof;
determine at least one seed value associated with the device, the user of the device, or a combination thereof; and
process and/or facilitate a processing of the at least one seed value to cause, at least in part, a generation of the one or more identifiers.

12. An apparatus of claim 11, wherein the apparatus is further caused to:
determine a first time use, an initialization, or a combination thereof of the device; and
cause, at least in part, generation of the at least one seed value based, at least in part, on the first time use, the initialization, or a combination thereof.

13. An apparatus of claim 12, wherein the generation of the at least one seed value is based, at least in part, on one or more random values.

14. An apparatus of claim 11, wherein the apparatus is further caused to:
receive another request to regenerate the one or more identifiers, to generate one or more other identifiers, or a combination thereof for the at least one service, at least one other service, or a combination thereof; and
process and/or facilitate a processing of the seed value to cause, at least in part, a regeneration of the one or more identifiers, a generation of the one or more other identifiers, or a combination thereof.

15. An apparatus of claim 11, wherein the generation of the one or more identifiers comprises:
determine (a) one or more service identifiers associated with the one or more services, the one or more applications, or a combination thereof, (b) one or more sequence numbers, (c) one or more other parameters, or (d) a combination thereof,
wherein the generation of the one or more identifiers is further based, at least in part, on the one or more service identifiers, the one or more sequence numbers, the one or more parameters, or a combination thereof.

16. An apparatus of claim 11, wherein the apparatus is further caused to:
determine to pre-generate at least one of the one or more identifiers for at least one of the one or more services, the one or more applications, or a combination thereof.

17. An apparatus of claim 16, wherein the at least one of the one or more services, the one or more applications, or a combination thereof are part of a single sign-on group.

18. An apparatus of claim 11, wherein the apparatus is further caused to:
process and/or facilitate a processing of the one or more identifiers based, at least, in part, on the at least one seed value to cause, at least in part, a correlation of the device, the user of the device, or a combination thereof to the one or more services, the one or more applications, or a combination thereof.

19. An apparatus of claim 18, wherein the apparatus is further caused to:
cause, at least in part, a restriction of access to the at least one seed value to one or more authorized entities,
wherein the correlation is performed by or on behalf of the one or more authorized entities.

20. An apparatus of claim 11, wherein the generation of the one or more identifiers is based, at least in part, on one or more encryption-based hash functions.
